(19) United States
(12) Patent Application Publication
(10) Pub. No.: US 2024/0112653 A1
(43) Pub. Date: Apr. 4, 2024

(54) ELECTRONIC DEVICE, ELECTRONIC MUSICAL INSTRUMENT SYSTEM, REPRODUCTION CONTROL METHOD, AND RECORDING MEDIUM

(71) Applicant: CASIO COMPUTER CO., LTD., Tokyo (JP)

(72) Inventors: Toshiyuki TACHIBANA, Tokyo (JP); Jun YOSHINO, Tokyo (JP)

(73) Assignee: CASIO COMPUTER CO., LTD., Tokyo (JP)

(21) Appl. No.: 18/367,545

(22) Filed: Sep. 13, 2023

(30) Foreign Application Priority Data
Oct. 4, 2022 (JP) 2022-160178

(51) Int. Cl. G10H 1/00; G10H 1/34; G10H 1/36

(52) U.S. Cl. CPC G10H 1/0016; G10H 1/34; G10H 1/361

(57) ABSTRACT

An electronic device including at least one processor that controls reproduction of a piece of music based on music data. The processor determines a performance section falling under a condition defined in advance in the piece of music as a first section and determines a section not falling under the condition as a second section, and in reproducing of the piece of music based on the music data, controls to output music sound of the first section and not to output at least a part of music sound of the second section.

### REFERENCE TO RELATED APPLICATIONS

This application is based upon and claims the benefit of priority from the prior Japanese Patent Application No. 2022-160178, filed on Oct. 4, 2022, the entire contents of which are incorporated herein by reference.

### TECHNICAL FIELD

The present disclosure relates to an electronic device, an electronic musical instrument system, a reproduction control method, and a recording medium.

### DESCRIPTION OF RELATED ART

In many conventional cases, when a user practices an electronic musical instrument such as a piano, automatic performance music as a guide (guidance) is reproduced to subsequently let the user perform in agreement with the guide, thereby achieving improvement of user performance.

On the other hand, there is also ad-lib performance of playing phrases in improvisational manners. For example, JP 2007-163710A describes a performance assisting device that assists ad-lib performance by determining keys which are usable in a performance period of a predetermined time duration from the current time point based on code designation information contained in performance information and controlling display to notify a user of the usable keys in display element stages associated in a time sequence.

### SUMMARY OF THE INVENTION

An electronic device of the present disclosure is an electronic device including at least one processor that controls reproduction of a piece of music based on music data. The processor determines a performance section falling under a condition defined in advance in the piece of music as a first section and determines a section not falling under the condition as a second section, and in reproducing of the piece of music based on the music data, controls to output music sound of the first section and not to output at least a part of music sound of the second section.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a diagram showing an overall configuration example of an electronic musical instrument system according to an embodiment of the present disclosure;

FIG. 2 is a flow chart showing a flow of melody part reproduction processing in ad-lib performance lesson processing executed by a controller of an electronic device;

FIG. 3 is a flow chart showing a flow of section determination processing executed in step S2 in FIG. 2;

FIG. 4 is a diagram showing guide performance sections and ad-lib performance sections determined by the section determination processing in FIG. 3; and

FIG. 5 is a diagram showing a screen display example of information indicating ad-lib performance sections and guide performance sections.

### DETAILED DESCRIPTION

Hereinafter, an embodiment of the present disclosure will be described with reference to the drawings. However, various limitations which are technically preferable for implementing the present disclosure are imposed on the embodiment which will be described below. Thus, the technical scope of the present disclosure is not limited to the following embodiment and illustrated examples.

[Configuration of Electronic Musical Instrument System 100]

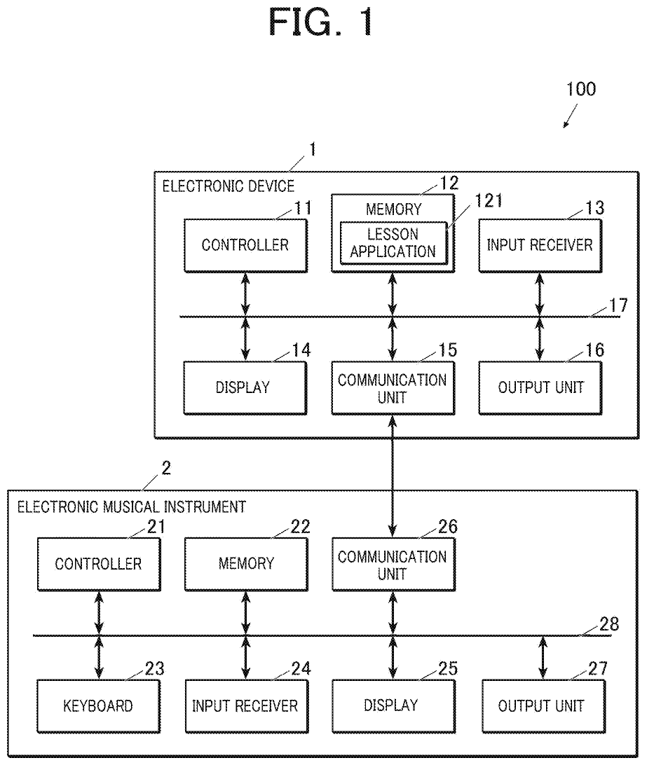

FIG. 1 is a diagram showing an overall configuration example of an electronic musical instrument system 100 according to the present disclosure.

As shown in FIG. 1, the electronic musical instrument system 100 includes an electronic device 1 and an electronic musical instrument 2. The electronic device 1 and the electronic musical instrument 2 are connected to communicate with each other for transmitting/receiving data to/from each other wirelessly or by wire.

[Configuration of Electronic Device 1]

The electronic device 1 is a device that offers an ad-lib performance lesson to a user of the electronic musical instrument 2. A tablet personal computer (PC), a notebook PC, a smartphone, or the like, for example, is applicable as the electronic device 1.

The electronic device 1 includes a controller 11, a memory 12, an input receiver 13, a display 14, a communication unit 15, an output unit 16, and the like, which are connected to each other with a bus 17, as shown in FIG. 1.

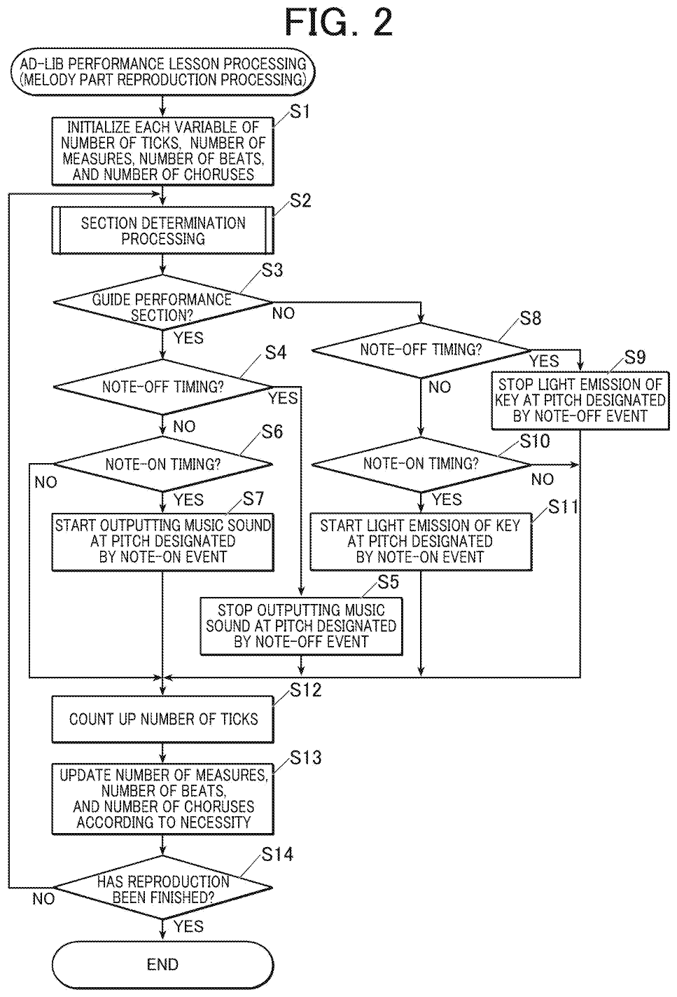

The controller 11 is a computer including a central processing unit (CPU) as at least one processor, a random access memory (RAM), and the like and controlling each part of the electronic device 1. Specifically, the CPU of the controller 11 reads out a designated program among a system program and various application programs stored in the memory 12 for expansion to the RAM, and executes various types of processing including ad-lib performance lesson processing shown in FIG. 2 in cooperation with the expanded program.

The memory 12 is configured by including a nonvolatile semiconductor memory, a hard disk drive (HDD), or the like. The memory 12 stores the system program of the electronic device 1, various application programs, and data required for execution of the programs. The memory 12 is not limited to the one provided in the electronic device 1, but may include an external recording medium which is attachable/detachable to/from the electronic device 1. In the present embodiment, the memory 12 stores an application program (which will be called a lesson application 121) for the controller 11 to execute the ad-lib performance lesson processing shown in FIG. 2.

The memory 12 also stores music data on a plurality of pieces of music, each of which is selectable as a lesson target in the lesson application 121, in association with a music number and a music title for identifying each piece of music. The music data is musical instrument digital interface (MIDI) format data such as a standard MIDI file (SMF), for example, and includes music data on each part (in the present embodiment, a melody part and an accompaniment part), that is, information about a note-on event (key pressing), information about a note-off event (key releasing), timing of a note-on event/note-off event (timing of key pressing/key releasing), tick information, beat information, information about chord progression, and the like in each part. The information about a note-on event (note-on message) is information indicating music sound, output of which is to be started, and includes channel information, a note number (pitch), and velocity information. The information about a note-off event (note-off message) is information indicating music sound, output of which is to be stopped, and at least includes channel information and information about the note number (pitch). The controller 11 determines the positions of separators of measures in music data based on the beat information and the tick information.

In the present embodiment, the piece of music which is selectable as a lesson target is composed of repetitions of a prescribed number of measures (choruses). The memory 12 stores, in association with the music number, the number of choruses (the number of repetitions) in the piece of music of the music number and the number of measures included in each chorus.

The input receiver 13 is configured by including a press button switch, a touch panel attached to the display 14, and the like. The input receiver 13 outputs, to the controller 11, a signal of an operation on the press button switch or a signal of an operation on the screen made by the user.

The display 14 is configured by including a liquid crystal display (LCD), an electro luminescence (EL) display, or the like, and presents various displays in accordance with display information instructed from the controller 11.

The communication unit 15 includes a wired unit or a wireless unit for communicating with an external device such as the electronic musical instrument 2, and transmits/receives data to/from the external device. In the present embodiment, the communication unit 15 transmits/receives data to/from the electronic musical instrument 2 via a communication interface (in the present embodiment, a MIDI interface) not shown.

The output unit 16 includes a sound source unit, a D/A converter, an amplifier, a speaker, and the like. The output unit 16 reads out waveform data stored in advance in a waveform ROM included in the sound source unit or generates waveform data with the sound source unit in accordance with an instruction from the controller 11, and outputs music sound based on the waveform data from the speaker via the D/A converter and the amplifier.

[Electronic Musical Instrument 2]

The electronic musical instrument 2 is a keyboard instrument, for example.

The electronic musical instrument 2 includes a controller 21, a memory 22, a keyboard 23, an input receiver 24, a display 25, a communication unit 26, an output unit 27, and the like, which are connected to each other with a bus 28, as shown in FIG. 1.

The controller 21 is a computer including at least one CPU, a RAM, and the like and controlling each part of the electronic musical instrument 2. Specifically, the CPU of the controller 21 reads out a designated program among a system program and various programs stored in the memory 22 for expansion to the RAM, and executes various types of processing in cooperation with the expanded program.

For example, the controller 21 causes the output unit 27 to output music sound in accordance with a performing operation on the keyboard 23.

When a note-on event transmitted from the electronic device 1 through a channel for melody is received with the communication unit 26, the controller 21 causes the output unit 27 to start outputting music sound at a pitch designated by the received note-on event. When a note-off event transmitted from the electronic device 1 through the channel for melody is received with the communication unit 26, the controller 21 causes the output unit 27 to stop outputting music sound at a pitch designated by the received note-off event.

When a note-on event transmitted from the electronic device 1 through a channel for guide display is received with the communication unit 26, the controller 21 causes the LED of the key in the keyboard 23 at a pitch designated by the received note-on event to emit light. When a note-off event transmitted from the electronic device 1 through the channel for guide display is received with the communication unit 26, the controller 21 turns off the LED of the key in the keyboard 23 at a pitch designated by the received note-off event.

The memory 22 is configured by including a nonvolatile semiconductor memory, a hard disk drive (HDD), or the like. The memory 22 stores the system program of the electronic musical instrument 2, various programs, and data required for execution of the programs. The memory 22 is not limited to the one included in the electronic musical instrument 2, but may include an external recording medium which is attachable/detachable to/from the electronic musical instrument 2.

The keyboard 23 includes a plurality of keys (operation elements), a detector that detects a pressed/released key, and the like, and outputs information about the pitch of the pressed/released key and the timing to the controller 21.

The plurality of keys of the keyboard 23 each include a light emitting diode (LED) which is a light emitter, and emit light in response to an instruction from the controller 21.

The input receiver 24 is configured by including a press button switch, a touch panel attached to the display 25, and the like. The input receiver 24 outputs, to the controller 21, a signal of an operation on the press button switch or a signal of an operation on the screen made by the user.

The display 25 is configured by including a liquid crystal display (LCD) or the like, and presents various displays in accordance with display information instructed from the controller 21.

The communication unit 26 includes a wired unit or a wireless unit for communicating with an external device such as the electronic device 1, and transmits/receives data to/from the external device. In the present embodiment, the communication unit 26 transmits/receives data to/from the electronic device 1 via a communication interface (in the present embodiment, a MIDI interface) not shown.

The output unit 27 includes a sound source unit, a D/A converter, an amplifier, a speaker, and the like. The output unit 27 reads out waveform data stored in advance in a waveform ROM included in the sound source unit or generates waveform data with the sound source unit in accordance with an instruction from the controller 21, and outputs music sound based on the waveform data from the speaker via the D/A converter and the amplifier.

[Operation of Electronic Musical Instrument System 100]

Next, an operation in the electronic musical instrument system 100 will be described.

When the lesson application 121 is launched in the electronic device 1 and a piece of music targeted for lesson is selected with the input receiver 13 and reproduction is instructed, the controller 11 executes the ad-lib performance lesson processing in cooperation with the lesson application 121.

Herein, a conventional lesson of an electronic musical instrument is aimed at helping a user to become able to play the musical instrument in accordance with a guidance, and reproducing the whole music of all parts as a guidance, reproducing the whole music with any part muted to enable the user to practice the part in time with other parts, or reproducing some phrases of a piece of music as a guidance and causing the user to play subsequently.

However, ad-lib performance is to uniquely create phrases during performance, and is therefore not suited for the conventional lesson aimed at helping a user to become able to play a musical instrument in accordance with a guidance. Therefore, reproducing the whole music of all parts as a guidance is nothing of practice of ad-lib performance required to have improvisation. On the other hand, in a case where there is no reproduction (automatic performance) as a guidance, the user needs to play the entire piece of music ad lib, which is a high hurdle and makes it difficult to increase the effect of practice.

Thus, in the ad-lib performance lesson processing, a piece of music based on music data targeted for lesson is reproduced providing a section (a first section which will be called a guide performance section) in which music sound is output (performed) and a section (a second section which will be called an ad-lib performance section) in which no music sound is output in order for the user to perform ad-lib performance following guide performance. At the time of reproduction, the piece of music is reproduced without disrupting progression (such as chord progression) of the piece of music targeted for lesson. That is to say, the piece of music is reproduced without stopping the progression of the piece of music to repeat some portions or providing a waiting time for user performance. This provides an effective lesson of ad-lib performance for the user.

The ad-lib performance lesson processing includes melody part reproduction processing and accompaniment part reproduction processing. The controller 11 executes the melody part reproduction processing and the accompaniment part reproduction processing simultaneously with synchronized counting up of the number of ticks, for example.

Hereinafter, each part reproduction processing in the ad-lib performance lesson processing will be described.

The following description will be given using, as an example, a case of providing the melody part with guide performance sections and ad-lib performance sections and offering a lesson of ad-lib performance for the melody part. The description will also be given using, as an example, a case in which a piece of music targeted for lesson is composed of three choruses, each of which goes round in twelve measures. The guide performance section and the ad-lib performance section are sections each having the number of measures defined in advance (herein, four measures), and description will be given using, as an example, a case in which the guide performance section and the ad-lib performance section alternately switch around every four measures.

FIG. 2 is a flow chart showing a flow of the melody part reproduction processing executed by the controller 11. First, the melody part reproduction processing will be described with reference to FIG. 2.

In the melody part reproduction processing, the controller 11 first initializes each variable (a memory area of the RAM) of the number of ticks, the number of measures, the number of beats, and the number of choruses (step S1).

That is to say, the controller 11 sets each variable (the memory area of the RAM) of the number of ticks, the number of measures, the number of beats, and the number of choruses at 0. Each variable of the number of ticks, the number of measures, the number of beats, and the number of choruses is a variable for specifying the position currently targeted for reproduction in a piece of music.

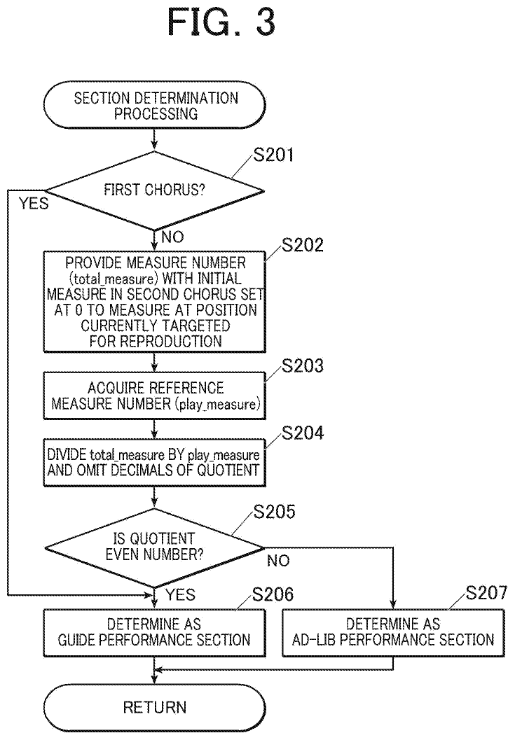

The controller 11 then executes section determination processing shown in FIG. 3 to determine the position currently targeted for reproduction as the guide performance section or the ad-lib performance section (step S2).

Herein, the section determination processing executed in step S2 in FIG. 2 will be described with reference to FIG. 3. The section determination processing shown in FIG. 3 is executed by cooperation between the controller 11 and the lesson application 121.

The controller 11 first figures out whether or not the position currently targeted for reproduction is in an initial chorus (a first chorus, that is, the number of choruses=0) (step S201).

In other words, the controller 11 figures out whether or not the position currently targeted for reproduction is in the initial twelve measures of the piece of music.

If it is figured out that the position currently targeted for reproduction is in the initial chorus (the number of choruses=0) (YES in step S201), the controller 11 determines the position currently targeted for reproduction as the guide performance section (step S206), and returns to step S3 in FIG. 2.

Herein, in the present embodiment, all sections of the initial first chorus are determined as the guide performance sections such that the user is able to grasp an image of the piece of music.

If it is figured out that the position currently targeted for reproduction is not in the initial chorus (the number of choruses=0) (NO in step S201), the controller 11 calculates a measure number (total_measure) of a measure currently targeted for reproduction in a case where the measure number of the leading measure of the second chorus is set at 0, and provides the calculated measure number (total_measure) to the measure currently targeted for reproduction (step S202).

For example, in the case where the first chorus is composed of twelve measures as described above, the initial measure of the third chorus is provided with the measure number of 12.

The controller 11 then acquires the number of measures (the reference measure number (play_measure)) of the guide performance section and the ad-lib performance section (step S203).

Since the number of measures of the guide performance section and the ad-lib performance section is four in the present embodiment as described above, the controller 11 acquires four as the reference measure number (play_measure). The reference measure number shall be stored in advance in the memory 12, but may be set optionally by the user through the input receiver 13.

The controller 11 then divides the measure number (total_measure) by the reference measure number (play_measure) to calculate a quotient, and omits decimals of the quotient (step S204).

This calculation enables acquisition of what number measure by the unit of four measures the measure currently targeted for reproduction is.

The controller 11 then figures out whether or not the value calculated in step S204 is an even number (step S205).

If it is figured out that the value calculated in step S204 is an even number (YES in step S205), the controller 11 determines the measure currently targeted for reproduction as the guide performance section (step S206), and proceeds to step S3 in FIG. 2.

If it is figured out that the value calculated in step S204 is an odd number (NO in step S205), the controller 11 determines the measure currently targeted for reproduction as the ad-lib performance section (step S207), and proceeds to step S3 in FIG. 2.

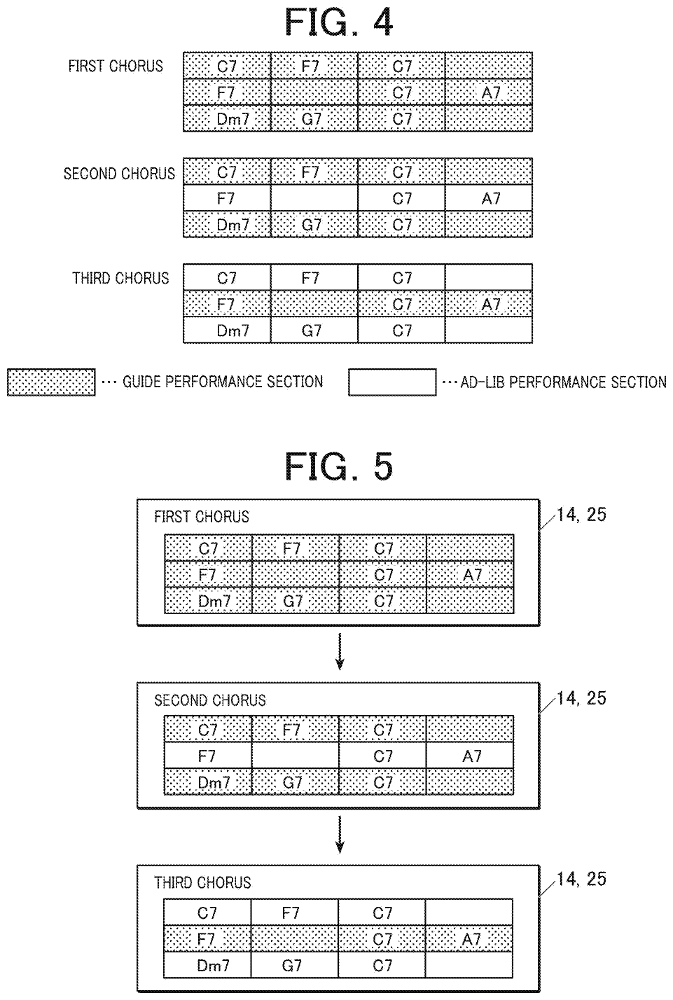

FIG. 4 is a diagram showing an example of guide performance sections and ad-lib performance sections determined in the above-described section determination processing. In FIG. 4, one rectangular region indicates one measure, and measures in a piece of music are separated for each chorus (every twelve measures), with each row including four measures. In FIG. 4, a left upper rectangular region C7 in the first chorus is the initial measure, and performance progresses from left to right similarly to a usual staff notation. When one row (four rectangular regions) is finished, performance progresses to the leftmost rectangular region (F7 in FIG. 4) in the next row. The symbol such as C7 or F7 in each rectangular region indicates a chord in the measure. No chord is described for a measure having the same chord as that of the previous measure.

As shown in FIG. 4, in the above-described section determination processing, all measures of the first chorus are determined as a guide performance section to enable the user to grasp the image of the piece of music. The second and subsequent choruses are determined such that a guide performance section and an ad-lib performance section alternate every four measures. The second and subsequent choruses are also determined such that guide performance sections and ad-lib performance sections vary for each chorus.

In step S3 in FIG. 2, the controller 11 figures out whether or not the position currently targeted for reproduction is in a guide performance section based on a result of the section determination processing (step S3).

If it is figured out that the position currently targeted for reproduction is in the guide performance section (YES in step S3), the controller 11 figures out whether or not the position currently targeted for reproduction is a note-off timing based on music data on the melody part (step S4).

If it is figured out that the position currently targeted for reproduction is the note-off timing (YES in step S4), the controller 11 transmits a note-off event corresponding to the current reproduction position of the music data on the melody part to the electronic musical instrument 2 with the communication unit 15 through the channel for melody, thereby causing the electronic musical instrument 2 to stop outputting music sound at the pitch designated by the note-off event (step S5), and proceeds to step 312.

If it is figured out that the position currently targeted for reproduction is not the note-off timing (NO in step S4), the controller 11 figures out whether or not the position currently targeted for reproduction is a note-on timing based on the music data on the melody part (step S6).

If it is figured out that the position currently targeted for reproduction is the note-on timing (YES in step S6), the controller 11 transmits a note-on event corresponding to the current reproduction position of the music data on the melody part to the electronic musical instrument 2 with the communication unit 15 through the channel for melody, thereby causing the electronic musical instrument 2 to start outputting music sound at the pitch designated by the note-on event (step S7), and proceeds to step S12.

If it is figured out that the position currently targeted for reproduction is not the note-on timing (NO in step S6), the controller 11 proceeds to step S12.

On the other hand, when it is figured out in step S3 that the position currently targeted for reproduction is not in a guide performance section (that is, an ad-lib performance section) (NO in step S3), the controller 11 figures out whether or not the position currently targeted for reproduction is the note-off timing based on the music data on the melody part (step S8).

If it is figured out that the position currently targeted for reproduction is the note-off timing (YES in step S8), the controller 11 transmits a note-off event corresponding to the current reproduction position of the music data on the melody part to the electronic musical instrument 2 with the communication unit 15 through the channel for guide display, thereby causing the electronic musical instrument 2 to stop light emission of the LED of the key at the pitch designated by the note-off event (step S9), and proceeds to step S12.

If it is figured out that the position currently targeted for reproduction is not the note-off timing (NO in step S8), the controller 11 figures out whether or not the position currently targeted for reproduction is the note-on timing based on the music data on the melody part (step S10).

If it is figured out that the position currently targeted for reproduction is the note-on timing (YES in step S10), the controller 11 transmits a note-on event corresponding to the current reproduction position of the music data on the melody part to the electronic musical instrument 2 with the communication unit 15 through the channel for guide display, thereby causing the electronic musical instrument 2 to start light emission of the LED of the key at the pitch designated by the note-on event (step S11), and proceeds to step S12.

If it is figured out that the position currently targeted for reproduction is not the note-on timing (NO in step S10), the controller 11 proceeds to step S12.

In step S12, the controller 11 counts up the number of ticks (step S12), and updates a variable among the variables of the number of beats, the number of measures, and the number of choruses as required by counting up of the number of ticks (step S13).

For example, when one beat equals to 480 ticks, the number of beats is counted up each time the number of ticks is increased by 480.

The controller 11 then figures out whether or not reproduction of the selected piece of music has been finished (step S14). For example, the controller 11 figures out whether or not reproduction of the selected piece of music has been finished based on whether or not the number of ticks reaches a predetermined count.

If it is figured out that reproduction of the selected piece of music has not been finished (NO in step S14), the controller 11 returns to step S2.

If it is figured out that reproduction of the selected piece of music has been finished (YES in step S14), the controller 11 finishes the melody part reproduction processing.

As described above, in the melody part reproduction processing, when the piece of music targeted for lesson is reproduced, control is exerted such that music sound is output in guide performance sections and at least a part of music sound is not output in ad-lib performance sections. This enables the user to carry out ad-lib performance following guide performance and to experience an ad-lib lesson actually developed between a teacher and a student and a feeling of session by call and response, thus enabling effective practice of ad-lib performance.

In the melody part reproduction processing, the electronic musical instrument 2 is caused to light up (present guide display) the position of the key corresponding to the pitch in the ad-lib performance section at timing of performing in the ad-lib performance section. Thus, keys to be originally played following a score emit light, thus enabling the user to grasp reference pitches, scale, and the like.

The accompaniment part reproduction processing is processing without processing of steps S2, S3, and S8 to S11 in the melody part reproduction processing shown in FIG. 2. Steps S4 to S7 are executed based on music data on the accompaniment part. That is to say, the controller 11 controls the electronic musical instrument 2 to output music sound in all sections of the accompaniment part of the selected piece of music in the accompaniment part reproduction processing.

In the ad-lib performance lesson processing, the controller 11 executes the melody part reproduction processing and the accompaniment part reproduction processing in synchronization and simultaneously as described above. Thus, music sound of both the melody and accompaniment is output (played) in guide performance sections, and only the accompaniment sound is output in ad-lib performance sections. This enables the user to effectively practice ad-lib performance of the melody part in time with the accompaniment.

As described above, the controller 11 of the electronic device 1 determines a performance section falling under a condition defined in advance in a piece of music targeted for lesson as a guide performance section, and determines a section not falling under the condition as an ad-lib performance section. The controller 11 then exerts control such that in the case of reproducing the piece of music based on music data on the piece of music targeted for lesson, music sound of the determined guide performance section is output and at least a part (in the present embodiment, the melody part) of music sound of the ad-lib performance section is not output.

Consequently, control is exerted such that at least a part of the music sound is not output for the ad-lib performance section. This enables the user to actively carry out ad-lib performance following guide performance and to experience an ad-lib lesson actually developed between a teacher and a student and a feeling of session by call and response, thus enabling effective practice of ad-lib performance.

For example, a measure number is provided for each measure of the piece of music, and the controller 11 determines, as a guide performance section, the measure for which a quotient obtained by dividing the measure number by the reference measure number falls under the condition defined in advance, and determines a measure not falling under the condition defined in advance as an ad-lib performance section. Consequently, the guide performance section and the ad-lib performance section are easily determined.

For example, the controller 11 determines the first chorus (a prescribed number of measures at the beginning of the piece of music) as a guide performance section. This enables the user to grasp the image of the piece of music at the initial first chorus.

In a case where the piece of music is composed of repetitions of the first chorus, for example, the condition for determining sections is set such that the combination of measures which will constitute a guide performance section and measures which will constitute an ad-lib performance section is different depending on the repetition (depending on what number chorus). This enables the user to carry out ad-lib performance of various measures, thus enabling effective practice of ad-lib performance.

In a case where music data contains music data on each of a plurality of parts, for example, the controller 11 executes control of providing music of a first part (for example, the melody part) among the plurality of parts with guide performance sections and ad-lib performance sections, and exerts control of outputting music sound for all sections for at least one part (for example, the accompaniment part) different from the first part.

Consequently, the user is able to practice ad-lib performance of a part in which he/she wishes to carry out ad-lib performance effectively in time with performance of another part.

The described content in the above-described embodiment is a suitable example of an electronic device, an electronic musical instrument system, a reproduction control method, and a recording medium according to the present disclosure, and the present disclosure is not limited to this.

For example, the controller 11 may determine in advance guide performance sections and ad-lib performance sections of the piece of music targeted for reproduction before executing the above-described melody part reproduction processing, and may display information indicating the ad-lib performance sections and the guide performance sections in the piece of music targeted for reproduction on the display 14 or the display 25.

FIG. 5 is a diagram showing a display example of information indicating guide performance sections and ad-lib performance sections. FIG. 5 shows a display example of information indicating the guide performance sections and the ad-lib performance sections of the piece of music shown in FIG. 4.

For example, the controller 11 determines in advance guide performance sections and ad-lib performance sections of the piece of music targeted for reproduction, and before reproducing the first chorus, displays a chord score of music of the first chorus on the display 14 (the display 25) as shown in FIG. 5 and displays guide performance sections and ad-lib performance sections of the chord score in corresponding colors, respectively (different colors from each other). The controller 11 may display the current measure (a rectangular region) in a further different color for emphasis, and may display a cursor (an arrow or a vertical line) so as to move across the rectangular regions from left to right in time with the current performance timing. Since the first chorus entirely constitutes a guide performance section as described above, the controller 11 causes the chord score of music of the first chorus to be entirely displayed in a color corresponding to the guide performance section. When the first chorus is finished, the controller 11 causes a chord score of music of the second chorus to be displayed on the display 14 (the display 25), and causes guide performance sections and ad-lib performance sections of the chord score to be displayed in corresponding colors, respectively. When the second chorus is finished, the controller 11 causes a chord score of music of the third chorus to be displayed on the display 14 (the display 25), and causes guide performance sections and ad-lib performance sections of the chord score to be displayed in corresponding colors, respectively. This enables the user to be informed in advance of which section and by which performance method he/she should play.

In the above-described embodiment, ad-lib performance sections and guide performance sections in the piece of music targeted for reproduction are determined depending on whether the quotient obtained by dividing the measure number provided for each measure of the piece of music targeted for reproduction by the reference measure number is an odd number or an even number, however, the condition for determining sections is not limited to this.

For example, in a case where one chorus is composed of a multiple of four, such as 32 measures, guide performance sections and ad-lib performance sections in each chorus will be equal assuming that the ad-lib performance sections and the guide performance sections are each composed of four measures as in the above-described embodiment. When the guide performance sections and the ad-lib performance sections in each chorus are equal, the user is only able to experience ad-lib performance of the same place, resulting in ineffective practice. Thus, in such a case, the controller 11 may determine guide performance sections and ad-lib performance sections based on an integer portion of a quotient obtained by dividing the value (the measure number provided for each measure) obtained in step S203 by a number other than four which is the reference measure number (play_measure). For example, the controller 11 may determine measures for which a quotient obtained by dividing the value (the measure number provided for each measure) obtained in step S203 by 3 is 1 (or 3) as guide performance sections and other measures as ad-lib performance sections. This enables ad-lib performance sections to be different in each chorus, thus improving the effect of practice of ad-lib performance.

Modes (for example, three modes in which the reference measure numbers are 2, 3, and 4) may be set in advance for each value of the reference measure number (play_measure) to allow the user to select a mode by user input to the input receiver before performance. This enables the level of difficulty of ad-lib performance sections to be set.

A table that designates guide performance sections and/or ad-lib performance sections may be stored in the memory 12 for each piece of music to allow the controller 11 to determine guide performance sections and ad-lib performance sections based on the content of the table. For example, in a case where guide performance sections are designated in the table, the controller 11 determines the sections designated in the table as guide performance sections and sections not designated in the table as ad-lib performance sections. For example, in a case where ad-lib performance sections are designated in the table, the controller 11 determines sections not designated in the table as guide performance sections and the sections designated in the table as ad-lib performance sections. For example, in a case where guide performance sections and ad-lib performance sections are designated in the table, the controller 11 determines sections designated as guide performance sections (ad-lib performance sections) in the table as guide performance sections (ad-lib performance sections) and other sections as ad-lib performance sections (guide performance sections).

In the above-described embodiment, the controller 11 determines a section falling under the condition defined in advance, for example, a section of measures whose measure numbers are even numbers as a guide performance section, and determines a section not falling under the condition defined in advance, for example, a section of measures whose measure numbers are not even numbers as an ad-lib performance section. However, the controller 11 may determine a section falling under the condition defined in advance as an ad-lib performance section and determine a section not falling under the condition defined in advance as a guide performance section. Rather than the expression as to whether or not a section falls under the condition defined in advance, an expression as to whether a section falls under a first condition or a second condition defined in advance may be used.

The condition for determining guide performance sections and ad-lib performance sections may be changed for each reproduction (each time the user carries out an operation of reproducing a piece of music with the input receiver 13 or each time a piece of music is reproduced repeatedly).

For example, in a case of determining guide performance sections and ad-lib performance sections in a piece of music targeted for reproduction depending on whether the measure number provided for each measure of the piece of music targeted for reproduction is an odd number or an even number as described above, the controller 11 may change, for each reproduction, a section in a case where the measure number is an odd number between a guide performance section and an ad-lib performance section at random (or alternately).

The controller 11 may also change, for each reproduction, the number by which the measure number (total_measure) is divided or the number of quotient corresponding to a guide performance section or an ad-lib performance section. This enables various patterns of ad-lib performance sections and guide performance sections to be combined. The reference measure number (play_measure) may also be determined by a random number or the like at the start of reproduction and changed for each reproduction.

Also in the case of storing the table that designates guide performance sections and/or ad-lib performance sections in the memory 12 for each piece of music data and determining the guide performance sections and the ad-lib performance sections based on the content of the table, a plurality of tables different in content may be stored for each piece of music data and a table to be used may be changed for each reproduction sequentially or at random.

By changing the condition for determining guide performance sections and ad-lib performance sections for each reproduction as described above, the pattern of guide performance sections and ad-lib performance sections is variable for each reproduction, thus enabling the user to experience ad-lib performance of various places. This enables the user to practice ad-lib performance more effectively.

In the above-described embodiment, guide display is presented by causing the electronic musical instrument 2 to emit light at the position of the key at the pitch in the ad-lib performance section at timing of performance in the ad-lib performance section so as to guide the performance in the ad-lib performance section, however, the present disclosure is not limited to this. For example, the controller 11 may display a schematic diagram of the keyboard on the display 14 of the electronic device 1, and may present a guide display of the positions of keys corresponding to the pitches in the ad-lib performance section in the schematic diagram of the keyboard at timing of performing in the ad-lib performance section. This guide display may be displayed on the display 25 of the electronic musical instrument 2. This enables a guide when the user carries out ad-lib performance to be displayed even if LEDs are not mounted on the keys of the electronic musical instrument 2, and enables the user to grasp reference pitches, scale, and the like. It is therefore easier especially for beginners and intermediate level people to carry out ad-lib performance.

In the above-described embodiment, it has been described that the electronic musical instrument 2 is caused to emit light (present guide display) at the position of the key corresponding to the pitch in the ad-lib performance section at the timing of performing in the ad-lib performance section. However, the electronic musical instrument 2 may also be caused to emit light (present guide display) at the position of the key corresponding to the pitch in the guide performance section at the timing of performing in the guide performance section. For the ad-lib performance section, keys in the keyboard 23 of the electronic musical instrument 2 that correspond to the pitches (scale) of the ad-lib performance section may be caused to emit light, that is, some or all of keys that may be played (keys which do not produce a feeling of strangeness if played) for ad-lib performance may be caused to emit light all the time in the ad-lib performance section. This enables utilization as a guide of ad-lib performance.

Although the above-described embodiment has been described using, as an example, the case of providing the melody part with guide performance sections and ad-lib performance sections, the present disclosure is not limited to this. The part provided with guide performance sections and ad-lib performance sections may be changed as appropriate in accordance with a user operation.

Although the above-described embodiment has been described using, as an example, the case in which a piece of music targeted for lesson is output from the output unit 27 of the electronic musical instrument 2, the piece of music targeted for lesson may be output from the output unit 16 of the electronic device 1.

Although the above-described embodiment has been described using, as an example, the case in which a piece of music is composed of a plurality of repetitions (choruses), the present disclosure is also applicable to a piece of music with no repetition. In this case, guide performance sections and ad-lib performance sections may be determined by, for example, providing each measure with a measure number with the measure number of the initial measure of the piece of music set at 0, and based on a quotient obtained by dividing the measure number by the reference measure number (based on whether the integer portion of the quotient is an odd number or an even number).

Guide performance sections and ad-lib performance sections may be determined based on a table defined in advance for each piece of music data. For example, control may be exerted such that approximately three patterns of combinations (measure patterns) of guide performance sections and ad-lib performance sections are set in advance for each piece of music data, and one of the measure patterns is selected at random for each repetition of a prescribed number of measures (choruses). This enables significant measures (such as a performance section that provides highlight, for example) to be set in advance as an ad-lib performance section for each piece of music data, thus enabling ad-lib performance in line with a theme of the piece of music.

When the initial measure pattern selected at random is finished (when the initial prescribed number of measures (choruses) is finished), at least one section of ad-lib performance sections in the initial measure pattern may be stored in the memory as ad-lib performance section history information, and the ad-lib performance section stored as the ad-lib performance section history information may be carried over to the next and subsequent measure patterns. That is to say, setting at least one section of ad-lib performance sections in the initial measure pattern as an ad-lib performance section also in the next and subsequent measure patterns increases the level of difficulty in practicing ad-lib performance. Similarly, ad-lib performance sections may be increased for each repetition of a prescribed number of measures (choruses) (each time the measure pattern is changed).

The above-described embodiment has been described using, as an example, the case in which the lesson application 121 for implementing the functions of the present disclosure is stored in the memory 12 of the electronic device 1 separate from the electronic musical instrument 2 and the functions of the controller of the present disclosure are implemented by the controller 11 of the electronic device 1. However, a program equivalent to the lesson application 121 for implementing the functions of the present disclosure may be stored in the memory 22 of the electronic musical instrument 2, and the functions of the controller of the electronic device of the present disclosure may be implemented by the controller 21 of the electronic musical instrument 2.

Although the above-described embodiment has been described using, as an example, the case in which the electronic musical instrument 2 is a keyboard instrument, the electronic musical instrument 2 may be another electronic musical instrument such as an electric guitar or a MIDI violin.

Although the above-described embodiment has disclosed the example in which a semiconductor memory or a hard disk is used as a computer-readable medium for the program according to the present disclosure, the present disclosure is not limited to this example. A portable recording medium such as an SSD or a CD-ROM is applicable as another computer-readable medium. Carrier waves are also applied as a medium for providing data on the program according to the present disclosure via a communication line.

Besides, a detailed configuration and detailed operation of each device constituting the electronic musical instrument system may also be modified as appropriate within a range not departing from the purport of the disclosure.

Although the embodiment and variations of the present disclosure have been described above, the technical scope of the present disclosure is not limited to the above-described embodiment, but is defined by terms of the appended claims. Further, an equivalent scope of the terms of the appended claims to which modifications not pertinent to the essence of the present disclosure are added is also involved in the technical scope of the present disclosure.

1. An electronic device comprising at least one processor that controls reproduction of a piece of music based on music data, wherein the processor
determines a performance section falling under a condition defined in advance in the piece of music as a first section and determines a section not falling under the condition as a second section, and
in reproducing of the piece of music based on the music data, controls to output music sound of the first section and not to output at least a part of music sound of the second section.

2. The electronic device according to claim 1, wherein the processor
determines, as the first section, a measure of the piece of music for which a quotient obtained by dividing a measure number provided for the measure by a predetermined reference measure number falls under the condition, and
determines, as the second section, a measure of the piece of music for which a quotient obtained by dividing a measure number provided for the measure by the reference measure number does not fall under the condition.

3. The electronic device according to claim 2, wherein the processor determines the first section and the second section in accordance with the condition as to which of an odd number and an even number an integer portion of the quotient is.

4. The electronic device according to claim 1, wherein the condition is set such that, for the piece of music that includes repetition of content of a prescribed number of a measure, a measure constituting the first section and a measure constituting the second section are different for each of the repetition.

5. The electronic device according to claim 2, further comprising an input receiver,
wherein the processor determines the first section and the second section using information about a value of the reference measure number input with the input receiver.

6. The electronic device according to claim 1, wherein the processor changes the condition each time the piece of music is reproduced.

7. The electronic device according to claim 1, wherein based on a plurality of measure patterns in each of which a combination of a measure constituting the first section and a measure constituting the second section is defined in advance, the processor selects one of the plurality of measure patterns each time a prescribed number of a measure is repeated.

8. The electronic device according to claim 1, further comprising a display,
wherein the processor causes the display to display information indicating the first section and the second section in the piece of music.

9. The electronic device according to claim 1, wherein the processor determines a prescribed number of a measure at beginning of the piece of music as the first section.

10. The electronic device according to claim 1, wherein the music data contains music data for each of a plurality of parts, and the processor controls to output music sound of the first section and not to output music sound of the second section for music of a first part among the plurality of parts, and controls to output music sound for all the sections for music of at least one part different from the first part among the plurality of parts.

11. The electronic device according to claim 1, further comprising a display,
wherein the processor causes the display to display a guide of a pitch in the second section at timing of performing in the second section of the piece of music.

12. An electronic musical instrument system comprising:
the electronic device according to claim 1; and
an electronic musical instrument,
wherein the processor of the electronic device controls output of the music sound in the electronic musical instrument based on the music data.

13. The electronic musical instrument system according to claim 12,
wherein the electronic musical instrument includes a keyboard including keys each of which has a light emitter therein, and
wherein the processor of the electronic device causes a key in the keyboard of the electronic musical instrument that corresponds to a pitch in the second section to emit light at timing of performing in the second section of the piece of music.

14. A reproduction control method comprising:
determining, by a computer that controls reproduction of a piece of music based on music data, a performance section falling under a condition defined in advance in the piece of music as a first section and determining a section not falling under the condition as a second section, and
in reproducing of the piece of music based on the music data, controlling to output music sound of the first section and not to output at least a part of music sound of the second section.

15. A computer-readable non-transitory recording medium having recorded thereon a program for causing a computer that controls reproduction of a piece of music based on music data to execute processing of:
determining a performance section falling under a condition defined in advance in the piece of music as a first section and determining a section not falling under the condition as a second section; and
in reproducing of the piece of music based on the music data, controlling to output music sound of the first section and not to output at least a part of music sound of the second section.
